(19) United States
(12) Patent Application Publication
(10) Pub. No.: US 2010/0280636 A1
(43) Pub. Date: Nov. 4, 2010

(54) BUILDING AUTOMATION SYSTEM CONTROLLER INCLUDING NETWORK MANAGEMENT FEATURES

(75) Inventors: Scott T. Holland, Brookfield, WI (US); Jerald P. Martocci, Greenfield, WI (US); Youngchoon Park, Brookfield, WI (US); James B. French, Carmel, IN (US); Carol Lomonaco, Milwaukee, WI (US); Theodore J. Humpal, Greenfield, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/770,434

(22) Filed: Apr. 29, 2010

Related U.S. Application Data
(60) Provisional application No. 61/174,942, filed on May 1, 2009.
(60) Provisional application No. 61/174,900, filed on May 1, 2009.

(51) Int. Cl. G06F 17/00

(52) U.S. Cl. 700/90

(57) ABSTRACT

A controller for use with a plurality of BAS devices and a plurality of IT devices includes a housing and communications interfaces for connecting to the plurality of BAS devices and for connecting to the plurality of IT devices. The controller further includes a network communication module configured to serve as a network switch for the BAS devices and the IT devices. The controller yet further includes a BAS module configured to manage the BAS devices.

### CROSS REFERENCE TO RELATED PATENT APPLICATIONS

This application claims the benefit of U.S. Provisional Application No. 61/174,900, filed May 1, 2009, and U.S. Provisional Application No. 61/174,942, filed May 1, 2009, both of which are incorporated by reference in their entirety.

### BACKGROUND

The present disclosure generally relates to systems, devices, and methods for managing building automation system (BAS) devices. Building automation systems are, in general, hardware and/or software systems configured to control, monitor, and manage devices in or around a building or building area. BAS subsystems or devices can include heating, ventilation, and air conditioning (HVAC) devices, security devices, lighting system devices, fire alerting system devices, elevator system devices, other devices that are capable of managing building functions, or any combination thereof.

### SUMMARY

One embodiment of the present invention relates to a controller for use with a plurality of BAS devices and a plurality of information technology (IT) devices. The controller includes a housing and communication interfaces for connecting to the plurality of BAS devices and for connecting to the plurality of IT devices. The controller further includes a network communications module configured to serve as a network switch for the BAS devices and the IT devices. The controller yet further includes a BAS module configured to manage the BAS devices.

Another embodiment of the present invention relates to a method for operating a BAS controller. The method includes using a network communications module of the BAS controller to detect the connection of a plurality of BAS devices to communications interfaces of the BAS controller. The method further includes using the network communications module to determine whether an uplink device for providing network addressing and naming services is active. In response to a determination that an uplink device for providing network addressing and naming services is not active, the method includes using the network communications module to provide network addressing and naming services to the plurality of BAS devices connected to the communications interfaces of the BAS controller. In response to a determination that the uplink device for providing network addressing and naming services is active, the method includes using the network communications module to discontinue the provision of network addressing and naming services to the plurality of BAS devices connected to the communications interfaces of the BAS controller.

Alternative exemplary embodiments relate to other features and combinations of features as may be generally recited in the claims.

### BRIEF DESCRIPTION OF THE FIGURES

The present invention will become more fully understood from the following detailed description, taken in conjunction with the accompanying figures, wherein like reference numerals refer to like elements, in which:

FIG. 1 is a diagram of a BAS controller, according to an exemplary embodiment;

FIG. 2A is a block diagram of a BAS controller, according to an exemplary embodiment;

FIG. 2B is a block diagram of a BAS controller, according to another exemplary embodiment;

FIG. 3A is a block diagram of a BAS controller, according to yet another exemplary embodiment;

FIG. 3B is a block diagram of a BAS controller, according to yet another exemplary embodiment;

FIG. 3C is a flow chart of a process for installing or commissioning a BAS, according to an exemplary embodiment;

FIG. 3D is a flow chart of a process for operating a BAS controller, according to an exemplary embodiment;

FIG. 4 is a detailed block diagram of a BAS controller (e.g., of FIGS. 1-2A), according to an exemplary embodiment;

FIG. 5 is a flow chart of a process for configuring a BAS controller and connected BAS devices, according to an exemplary embodiment;

FIG. 6 is a diagram of the BAS controller of FIG. 1 and the housing of the BAS controller, according to an exemplary embodiment;

FIGS. 7A-B are illustrations showing the linking of multiple BAS controllers, according to an exemplary embodiment; and

FIG. 8 is a detailed block diagram of a BAS controller and network communications module with a security certified portion and a security uncertified portion, according to an exemplary embodiment.

### DETAILED DESCRIPTION

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

Referring generally to the figures, a controller is shown that integrates a network communications module with one or more BAS modules. The network communications module is configured to provide network setup and traffic management for a plurality of connected devices (BAS or otherwise). A BAS module facilitates the configuration of BAS devices, processes data from the BAS devices, or provides user interfaces for configuring or monitoring the BAS devices. According to some exemplary embodiments, the network communications module and the BAS module work together (e.g., share information) to configure a network of connected devices (e.g., BAS devices and IT devices, BAS devices connected to an IT network via an uplink connection, etc.) for improved performance, given determined characteristics of the BAS devices, the IT devices, and the network. The controller advantageously uses securities and shared information to manage and configure the BAS devices and the IT devices.

The BAS as illustrated and discussed in the disclosure is an example of a BAS that may be used in conjunction with the systems and methods of the present disclosure. The BAS devices may be installed in any environment (e.g., an indoor area or an outdoor area) and may include any number of persons, buildings, spaces, zones, rooms, and any other object or area. The BAS may include METASYS building automation components sold by Johnson Controls, Inc. The BAS module(s) shown in the Figures may be METASYS building automation system compatible modules. For example, the BAS modules may be, or include features of, a METASYS Network Automation Engine (NAE) controller, METASYS supervisory controller, or a Johnson Controls METASYS compatible field controller.

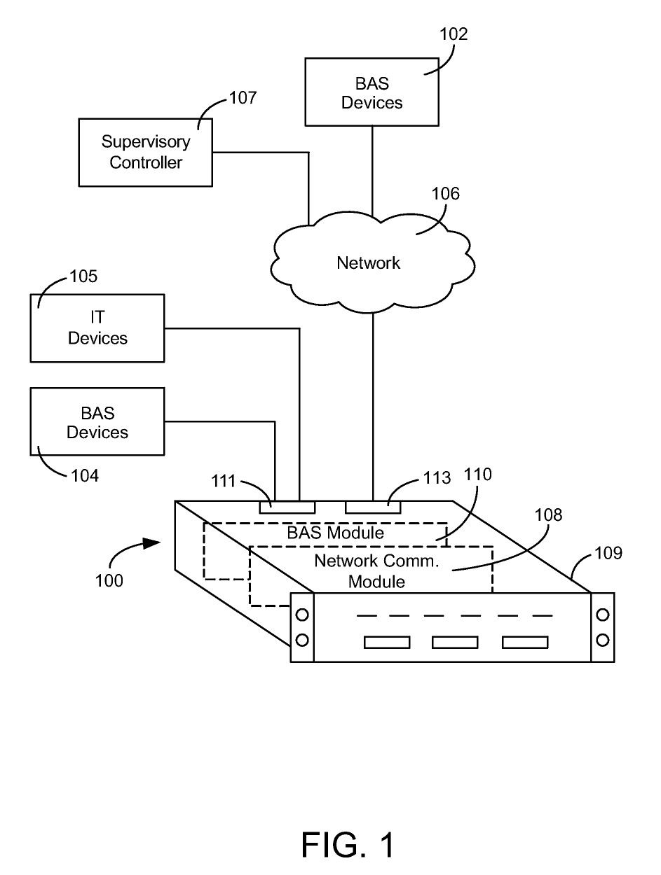

Referring now to FIG. 1, a controller 100 for use with a plurality of BAS devices 102, 104 and a plurality of IT devices 105 is shown, according to an exemplary embodiment. The controller includes a housing 109, communications interfaces 111 for connecting to the plurality of BAS devices 104, and an uplink interface 113. Controller 100 further includes a network communications module 108 configured to serve as a network switch for BAS devices 104 and IT devices 105. Controller 100 further includes a BAS module 110 configured to manage BAS devices 104 using BAS specific control algorithms. Controller 100 advantageously houses both BAS module 110 and network communication module 108. In an exemplary embodiment network communications module 108 and BAS module 110 are configured to share information for configuring a network including BAS devices 104 and IT devices 105.

Uplink interface 113 communicably connects controller 100 to an uplink network 106 which may include additional BAS devices 102 and supervisory controller 107. In an exemplary embodiment BAS controller 100 communicates with BAS devices 102 via a wired connection to network 106 and BAS controller 100 communicates with BAS devices 104 via wired connections. For example, communications interfaces 111 may be Ethernet interfaces for communicating with BAS devices 104 and IT devices 105 via Ethernet communications. Uplink interface 113 may also be an Ethernet interface for communicating with upstream network devices (e.g., upstream switches, Internet communications electronics, etc.). In other embodiments BAS controller 100 communicates with BAS devices 102, 104 via a wired connection or a wireless connection. For example, in addition to providing Ethernet ports, BAS controller 100 may include communications electronics for communicating over a ZigBee protocol-compatible wireless mesh network. In an exemplary embodiment the connection between BAS controller 100 and BAS devices 104 and IT devices 105 is an internet protocol (IP)-based connection. In other embodiments the communication connection between BAS controller 100 and BAS devices 104, IT devices 105, and network 106 may be analog, digital, or use any other suitable communications systems, methods, or protocols.

BAS controller 100 is configured to provide network setup and traffic management for BAS devices 104 and IT devices 105 using network communications module 108. BAS controller 100 can also configure BAS devices 102 or 104, store data received from BAS devices 102 or 104, and process the data received from BAS devices 102 or 104 using BAS module 110.

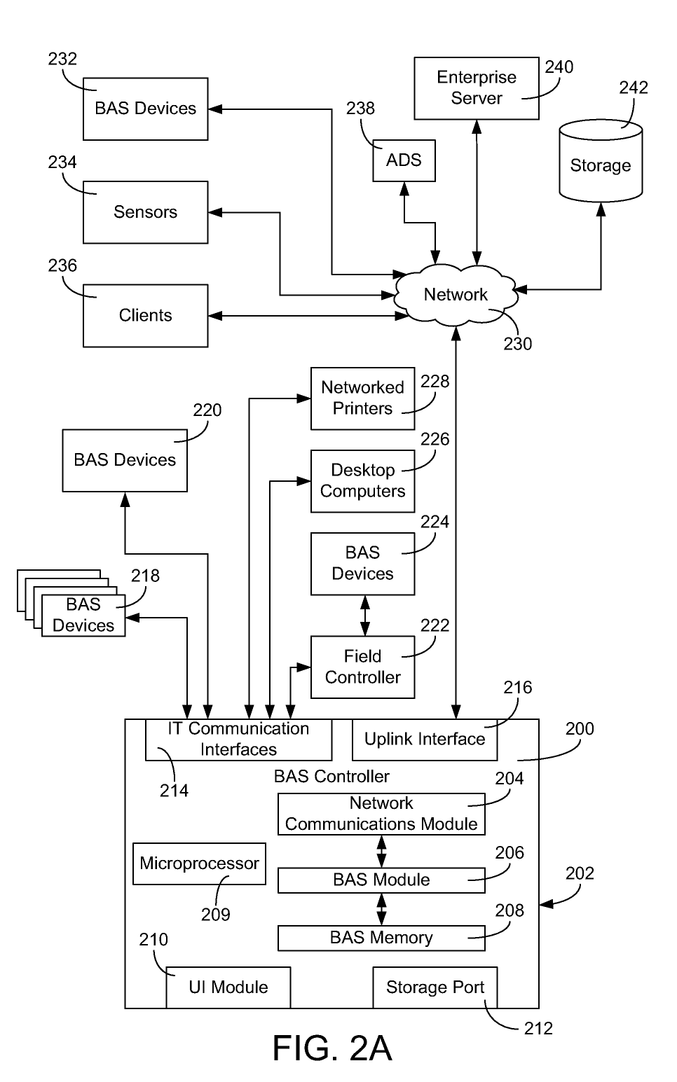

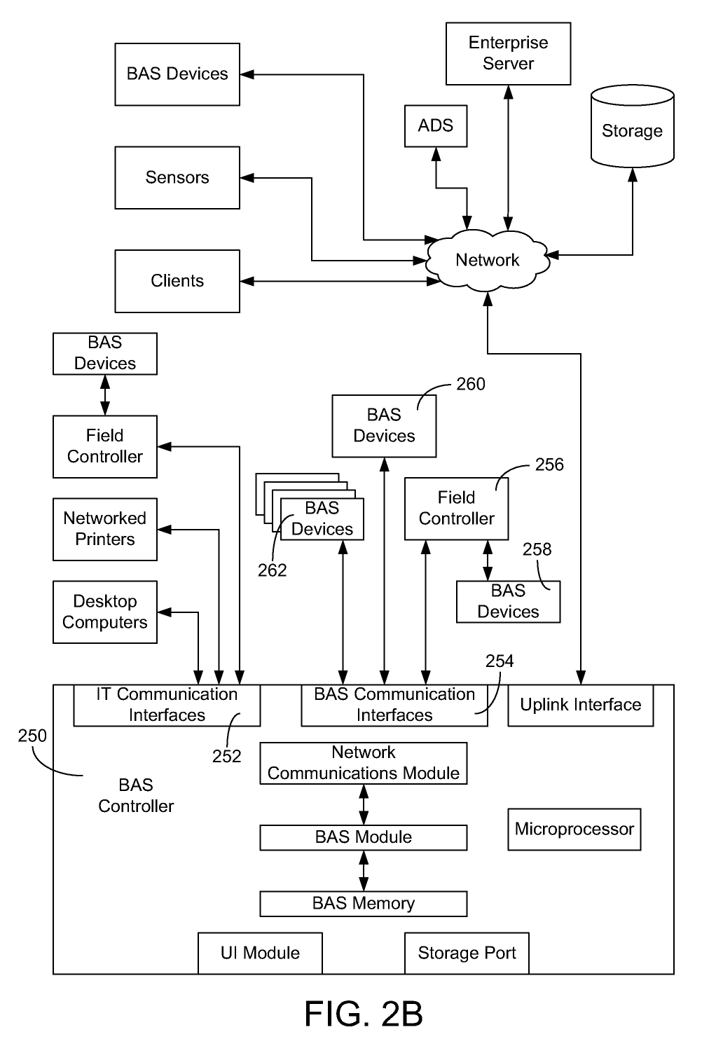

Referring now to FIG. 2A, a block diagram of another exemplary BAS controller 200 is shown. BAS controller 200 is shown as coupled to a plurality of BAS devices 218, 220 via IT communication interfaces 214 (e.g., terminals, ports, plug-ins, jacks, IEEE 802.3 compatible interfaces, interfaces compatible with BNC connectors, filters, modulators, demodulators, drivers, fiber optics interfaces, hardware interfaces compatible with RJ45 connectors, etc.). BAS devices 218, 220 may include different levels of processing capabilities ranging from having zero embedded processing capabilities (i.e., a device that provides an unprocessed output to the network) to having a significant processing component. For example, some of the BAS devices may be sensors that primarily communicate raw sensed information to BAS controller 200 via IT communication interfaces 214. Other BAS devices connected to IT communication interfaces 214 may include one or more field controllers 222 configured to provide downstream control to one or more other BAS devices 224 connected to field controller 222 (e.g., via a field bus connection) via a connection not compatible IT communicates interfaces 214. Other devices connected to IT communication interfaces 214 may include desktop computers 226, networked printers 228, or other IT devices.

BAS controller 200 is coupled to a network 230 via an uplink interface 216 (e.g., an Element interface, an RJ45 compatible female jack, a fiber optic jack, etc.). In the embodiment of FIG. 2A, uplink interface 216 is shown as separate from interfaces 214. According to other embodiments, IT communication interfaces 214 may include uplink interface 216.

Network 230 is shown connected to other BAS devices 232, one or more sensors 234, clients 236, an application data server (ADS) 238, an enterprise server 240, and storage 242. Clients 236 may display graphical user interfaces (GUIs) for interacting with BAS controller 200 and served by BAS module 206 or network communications module 204. The GUIs may be configured for interacting with the BAS devices or for configuring the BAS devices. Further, ADS 238 or BAS controller 200 may provide web-services or data services to clients 236. For example, BAS controller 200 may be configured to serve GUIs to clients 236 for allowing a user to view and change configuration options for network communications module 204 or BAS module 206. One or more network storage devices (e.g., memory, databases, storage 242, etc.) may also be connected to network 230 and used to store data from controller 200. Network communications module 204 may be configured to provide network setup and traffic management for the devices connected to IT communication interfaces 214 (e.g., BAS devices 218, 220, networked printers 228, desktop computers 226, field controller 222, etc.). BAS module 206 can configure and control BAS devices 218, 220, 222, or 224 connected to BAS controller 200. BAS module 206 may also (or alternatively) be configured to store BAS data from the BAS devices in BAS memory 208 or to process data received from the BAS devices 218, 220, 222, or 224. Yet further, BAS module 206 can be equipped to utilize inputs from BAS devices or from BAS memory 208 to conduct one or more control BAS algorithms.

According to an exemplary embodiment, network communications module 204 includes switching circuitry such that BAS controller 200 can operate as a network switch (e.g., a computer networking device that connects network segments, a device that routes and manages network traffic among/between a plurality of connected devices, an intelligent network switch, etc.). For example, network communications module 204 may be network communications hardware as provided in the Catalyst series of Ethernet switches sold by Cisco Systems, Inc. Network communications module 204 can include a set of hardware and a set of software for providing the activities of network communications module 204 described herein. For example, network communications module 204 may include computer code for execution by a microprocessor 209 of BAS controller 200. Network communications module 204 may include a printed circuit board or other circuitory that includes integrated circuits, switching circuitry, memory, and the like for providing and supporting the activities described herein with respect to network communications modules. Software for module 204 may be contained in BAS memory 208 and, when executed, configure microprocessor 209 or another integrated circuit or processor of BAS controller 200 for the activities described herein.

As shown in FIG. 2A, BAS module 206 is in communication with network communications module 204 and is housed within the device housing 202 of BAS controller 200. BAS module 206 configures and controls the various BAS devices (e.g., devices 218, 200, 222, 224, etc.) connected to IT communication interfaces 214, stores data in BAS memory 208, and processes the data received from the various BAS devices. BAS module 206 can include or be coupled to BAS memory 208. BAS memory 208 may store computer code for executing the activities of BAS module 206 described herein. BAS module 206 may be implemented in software, in hardware, or in both hardware and software.

Referring still to FIG. 2A, BAS controller 200 is further shown to include a user interface (UI) module 210 and a storage port 212. UI module 210 may include or be configured to control an electronic display (e.g., LCD display, OLED display, etc.), buttons, switches, keys, a touch screen, or any other user interface elements. Storage port 212 may be, for example, an iSCSI port, a USB port, or other type of port or connector for connecting BAS controller 200 to external storage devices.

Referring now to FIG. 2B, a block diagram of another BAS controller is shown, according to another exemplary embodiment. In the embodiment of FIG. 2B, BAS controller 250 is shown to include BAS communication interfaces 254 in addition to IT communication interfaces 252. A plurality of BAS devices 260, 262 may be connected to BAS communication interfaces 254 instead of or in addition to IT communication interfaces 252. BAS communication interfaces 254 may include an RS-485 terminal or an RS-232 terminal for communicating via BAS-specific communications protocols (e.g., modbus). BAS communication interfaces 254 may be connected to a field controller 256 for providing downstream control to one or more other BAS devices 258. BAS communication interfaces 254 can include one or more terminals, ports, plug-ins, jacks, or other interfaces compatible with BNC connectors, filters, modulators, demodulators, drivers, hardware interfaces compatible with RJ45 connectors, or other suitable interfaces for communicating with BAS devices 262, 260, 258, or 256 via parallel or serial communications.

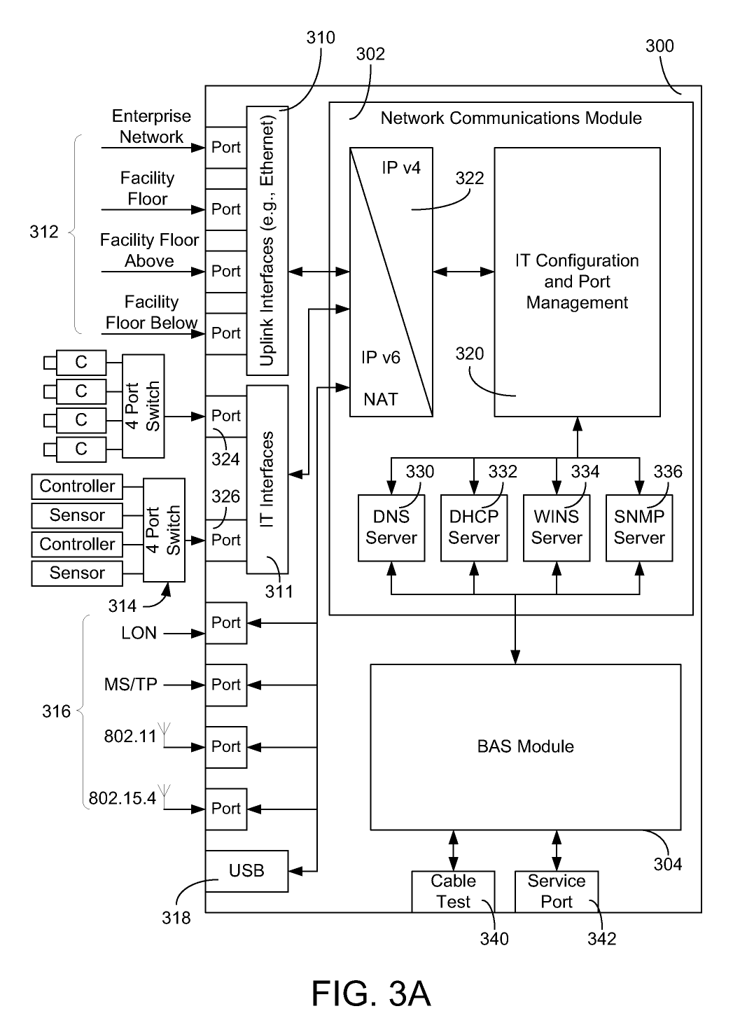

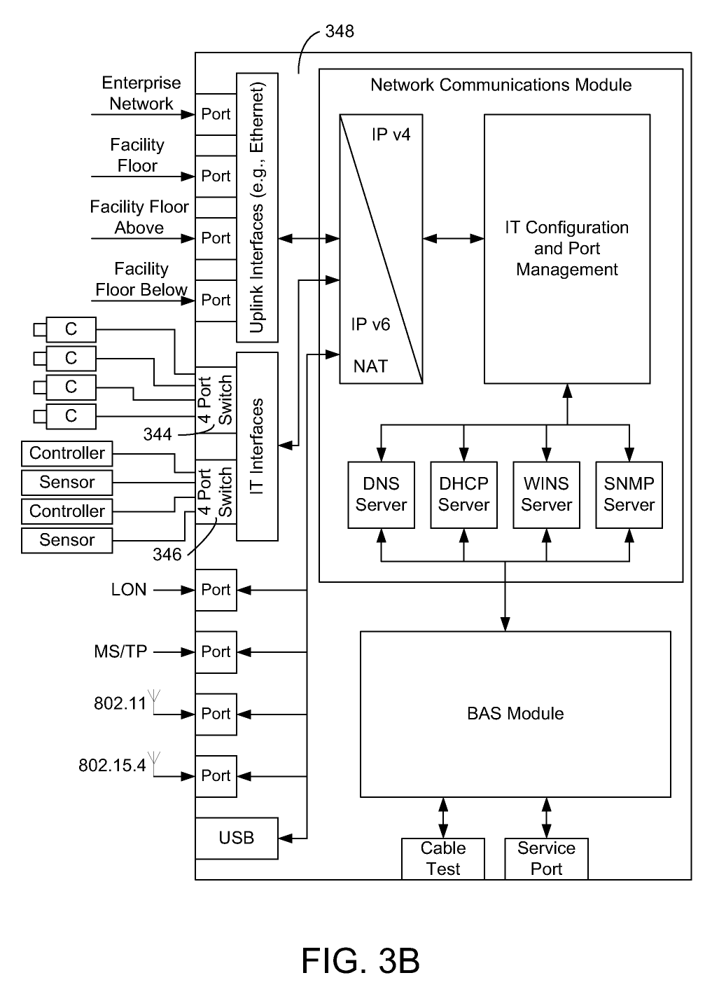

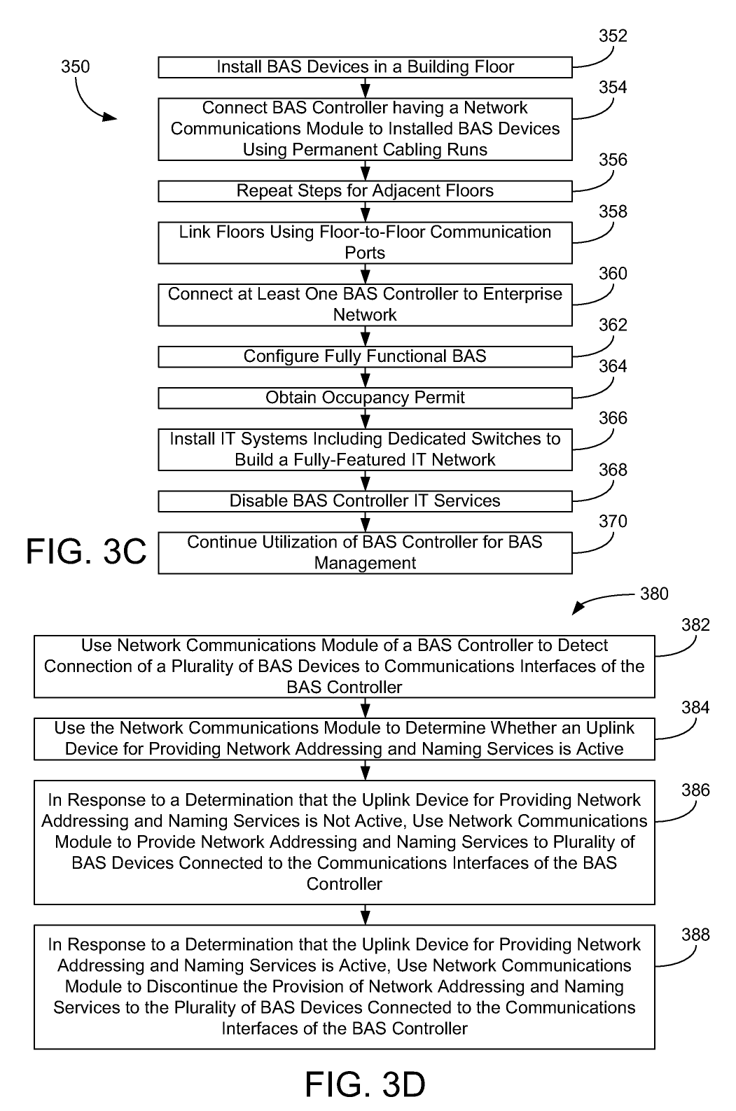

Referring now to FIG. 3A, a schematic diagram of a BAS controller 300 is shown, according to yet another exemplary embodiment. BAS controller 300 is shown to include uplink interfaces 310 (e.g., Ethernet ports) for connecting to network resources 312 from the BAS controller's facility floor, from facility floors above or below, or from an enterprise network.

BAS controller 300 further includes IT interfaces 311 (e.g., Ethernet ports) connected to switches (e.g., 4 port switches 314) allowing for a connection with multiple devices (e.g., cameras, controllers, sensors, etc.). According to one exemplary embodiment, IT interfaces 311 include a high speed IP port 324 for supporting video applications (e.g., videos from the cameras) or other bandwidth intensive BAS devices. Further, IT interfaces 311 additionally include a lower speed IP port 326 for supporting lower bandwidth BAS devices such as BAS sensors, BAS actuators, BAS controllers and the like.

BAS controller 300 further includes ports 316 for connecting to other BAS devices or IT devices. Ports 316 may be configured to support BAS device protocols such as BACnet, MS/TP, LON, or N2 or IT protocols (e.g., TCP/IP, UDP, FTP, etc.). Ports 316 may further be configured to support wireless ports of varying standards (e.g., IEEE 802.11 standards, IEEE 802.15.4 standards, etc.). BAS controller 300 may further include one or more universal serial bus (USB) ports 318 for connecting to BAS or IT devices (e.g., printers, flash drives, external hard drives, computer peripherals, etc.).

Network communications module 302 of BAS controller 300 includes network address translation (NAT) module 322. NAT module 322 maps packets received from devices connected to BAS controller 300 to another device connected to BAS controller 300 (e.g., a remote client requesting data from the device). NAT module 322 may use information stored in an address table to conduct its activity. NAT module 322 may operate by modifying network address information of packet headers transmitted between the devices and other network modes. In another embodiment NAT module 322 maps an address (e.g., logical port) for a device connected to BAS controller 300 to another address space or port using another suitable mapping method. NAT module 322 may be configured to hide the ports or address space for the devices via its activity. For example, NAT module 322 may be configured to modify and route packets so that communications to/from a public address or port are properly provided to/received from a private address or port. An address table may store the forward as well as the reverse lookup information for the network address translation, which may be the same or different. According to an exemplary embodiment, NAT module 322 is configured to translate between IPv4 and IPv6 protocols.

BAS controller 300 includes network communications module 302 and BAS module 304 which may operate as the other network communications modules and BAS modules described herein. Network communications module 302 further includes IT configuration and port management module 320. IT configuration and port management module 320 is connected to NAT module 322 and provides device information (e.g., network setup information for connected BAS or IT devices, traffic management information for the devices) to BAS devices and IT devices via interfaces 310, 311 and NAT module 322. IT configuration and port management module 320 and BAS module 304 may work together to retrieve configuration information (e.g., device types, device names, etc.) from connected devices. Controller 300 further includes one or more IT addressing or naming servers such as domain name system (DNS) server 330, dynamic host configuration protocol (DHCP) server 332, Windows internet name service (WINS) server 334, or other services for providing IT addressing or naming servers for a network. DNS server 330 can provide a hierarchical naming system to devices or other resources connected to BAS controller 300. DHCP server 332 provides connected BAS and IT devices with configuration information such as an IP address. Windows internet name service (WINS) server 334 maps host names of the BAS or IT devices to network addresses. Controller 300 also includes a simple network management protocol (SNMP) module 336 for monitoring the connected devices and detecting conditions that require attention.

According to an exemplary embodiment, the various IT addressing or naming servers (servers 322, 330-334) may be configured to automatically disable when an IT network is deployed. For example, BAS controller 300 may be installed with new BAS devices (e.g., HVAC system devices, lighting system devices, security system devices, fire system devices, etc.) in a building space (e.g., a new building floor). BAS controller 300 may be used to “build up” the BAS infrastructure and to serve as a key node of a temporary IT infrastructure as additional BAS devices and floors are installed (e.g., each floor may be disconnected from other floors in the BAS and then connected to other floors once the individual floors are “installed”).

In addition to the IT protocols discussed above, other IT protocols such as the file transfer protocol (FTP) or a hyper text transfer protocol (HTTP) may be used by BAS controller 300 (e.g., to allow for outbound archival of information, to allow for inbound file updates, etc.).

Controller 300 is advantageously a hybrid BAS/IT device that can be installed early in the building construction cycle and can be easily updated (not replaced) as the IT systems (permanent IT switches, etc.) are deployed. When the IT systems such as permanent IT routers, switches, or IT addressing and naming servers are deployed, the IT capabilities of the controller 300 can be automatically (or manually) disabled, leaving a BAS controller but easing the transition between a construction-phase BAS and the final BAS installation.

During construction, the environment of a building can be challenging (humid, dusty, etc.). Unlike conventional IT devices which run in climate-controlled data centers, controller 300 may be fully sealed and/or well-cooled for durability during the construction phase. Controller 300 can support a fully functioning IT network (or portion thereof) via network communications module 302, NAT 322, IT configuration and port management element 320, IT addressing or naming servers 330-334, and SNMP server 336. In this way, controller 300 may advantageously support the installation, configuration, and operation of a floor's BAS devices/network before the IT network or system has been installed in a building. Conventionally, installers provide a temporary IT network or system while constructing a BAS network in a building and while obtaining occupancy permits (which can require functional BAS components). Once the occupancy permits are obtained the installers take down and remove the temporary IT network. The permanent IT network is then installed and re-integrated with the BAS. Using controller 300, a “one-box” BAS and IT solution can be provided floor by floor during the initial installation and using permanent IT cabling. Once occupancy permits are obtained, controller 300 can continue serving as both a BAS controller and an IT switch having IT services (e.g., DHCP, DNS, etc.). Alternatively, controller 300 can continue serving as a BAS controller while the IT switching and services are offloaded to particular IT devices. When IT switching and services are available from another device, controller 300 may include circuitry configured to automatically disable its switching or IT services.

BAS controller 300 is further shown to include cable test port 340. Cable test port 340 may be used by an installer of BAS controller 300 to verify proper cable settings (e.g., verify a cable was terminated properly, verify that a cable can transmit and receive information and has not been cut, crimped or crossed at some point, etc. BAS controller 300 further includes service port 342 for allowing a technician to connect a terminal to BAS controller 300 directly. The terminal connected via service port 342 may be used for initial installation and configuration activities. For example, initial communications parameters for BAS controller 300 may be set via the terminal connected to service port 342.

Referring now to FIG. 3B, another embodiment of a BAS controller 348 is shown. In FIG. 3B, the BAS controller 348 includes switches 344, 346 as opposed to being connected to switches as shown in the embodiment of FIG. 3A. The embodiment shown in FIG. 3B may be preferred when controller 300 is centrally located on a floor for simple and direct connection of BAS or IT devices to controller 348. The embodiment shown in FIG. 3A may be preferred when controller 300 is not centrally located or it is for another reason desirable to provide switches 314 shown in FIG. 3A to remote areas of a floor.

Referring now to FIG. 3C, a flow chart of a process 350 for establishing a BAS using a controller 300 such as that described with reference to FIGS. 3A and 3B is shown, according to an exemplary embodiment. Process 350 includes installing BAS devices (step 352) in a building floor for a new construction or renovation. Process 350 further includes connecting a BAS controller (such as controller 300 having a network communications module and a BAS module) to the installed BAS devices using permanent network cabling runs (step 354). Process 350 further includes repeating the steps of installing BAS devices and connecting a BAS controller to the installed BAS devices for adjacent floors (step 356). At the end of step 356, for example, each floor may include a BAS controller connected to BAS devices using permanent cabling runs.

Each of the floors' controllers are then linked using floor-to-floor communication ports (step 358) (e.g., BAS controllers from adjacent floors are daisy-chained together to allow for BAS-wide communication prior to a full IT infrastructure being installed to the building). Process 350 further includes connecting at least one of the BAS controllers used to connect to facility building devices to an enterprise network (step 360). The enterprise network may be used for logging information regarding the BAS, for allowing a client (e.g., a web browser) to connect to GUIs served by the various BAS controllers, or for allowing an application and data server to connect to the BAS controllers and to coordinate the control of the BAS controllers. Process 350 further includes configuring a fully functional BAS (step 362). Such configuration may be conducted via the aforementioned GUIs or application and data servers (e.g., a METASYS ADS or a METASYS NAE, both sold by Johnson Controls)

Process 350 further includes obtaining an occupancy permit (step 364) for the building and based-in part on the operation and installation of the BAS. Once the permit is obtained, process 350 may continue with installing an IT system including dedicated switches to a building enterprise network (step 366). Process 350 further includes disabling BAS controller IT services (step 368) (e.g., the network addressing and naming services, the switching services, etc.). The IT services for the BAS controller are disabled (e.g., automatically, in response to detection by the BAS controller) as the IT network is deployed, allowing for the fully-featured IT network to be merged into the BAS established by the installed floor-by-floor BAS controllers. Such IT services may include DNS, DHCP, SNMP, WINS, or NAT functions as described in FIG. 3A. Process 350 further includes continuing utilization of the newly installed IT system for the BAS controller for BAS management (step 370).

Referring now to FIG. 3D, a flow chart of a process 380 for operating a BAS controller such as BAS controller 300 of FIG. 3A is shown, according to an exemplary embodiment. Process 380 includes detecting a connection of a plurality of BAS devices to the communications interfaces of a BAS controller (step 382). The BAS devices may be connected to the BAS controller via a communications interface (e.g., via an uplink interface of the BAS controller, via an IT interface of the BAS controller, via a 4 port switch connected or part of the BAS controller, via a wireless interface, etc.). Process 380 further includes determining whether an uplink device for providing network addressing and naming services is active (step 384). In other words, at step 384 the network communications module may determine another uplink services such as DHCP, DNS. NAT, WINS, SNMP, etc. are available.

Process 380 further includes, in response to a determination that the uplink device for providing network addressing and naming services is not active, using the network communications module to provide network address and naming services to the BAS devices connected to the communications interfaces of the BAS controller (step 386). The network address and naming services provided to the BAS devices may be provided by a NAT server, DNS server, DHCP server, WINS server, SNMP server, or another module of the BAS controller configured to provide such activities.

Process 380 also includes, in response to a determination that the uplink device for providing network addressing and naming services is active, using the network communications module to discontinue the provision of network addressing and naming services to the plurality of BAS devices connected to the communications interfaces of the BAS controller (step 388). The discontinuing of the services may allow the newly installed or fully-functional IT network to be merged with the already installed BAS controller.

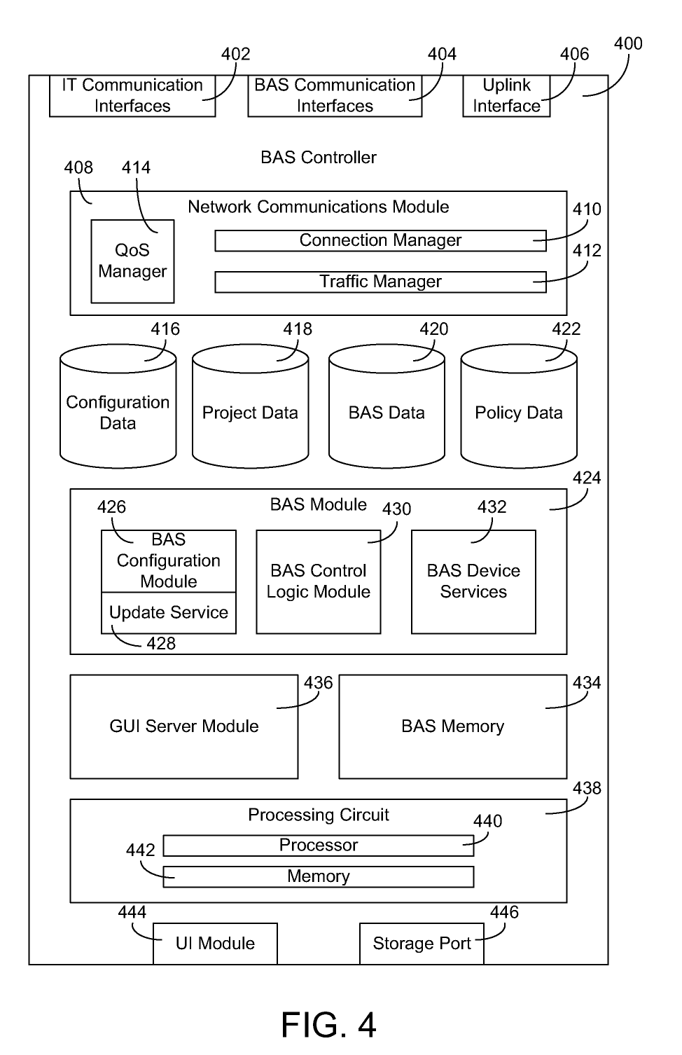

Referring now to FIG. 4, a detailed block diagram of a BAS controller such as that of FIGS. 1-2B is shown, according to an exemplary embodiment. BAS controller 400 is shown to include network communications module 408, BAS module 424, BAS memory 434, GUI server module 436, and a processing circuit 438.

Network communications module 408 is shown to include a connection manager 410. Connection manager 410 may be a hardware module (e.g., an application specific integrated circuit), a software module, or a hardware module that executes software. Connection manager 410 facilitates the configuration of devices connected to the communication interfaces (e.g., IT communication interfaces 402, BAS communication interfaces 404, uplink interface 406) of BAS controller 400. Connection manager 410 may include a DHCP server element configured to allow network devices coupled to interfaces 402, 404, 406 to obtain parameters for networked communications (e.g., obtain parameters for internet protocol (IP) communications, obtain private IP addresses, etc.). According to an exemplary embodiment, the DHCP server may be turned on or off by a user command received at a user interface, by signals received via uplink interface 406 or other interfaces 402, 404, or by any other mechanism. For example, when IP addresses are managed by a DHCP server remote from BAS controller 400 (e.g., a corporate level DHCP server, an enterprise level DHCP server, a network management system shown in FIG. 2A, etc.), BAS controller 400 may automatically disable its DHCP serving feature.

Network communications module 408 is shown to include a traffic manager 412. Traffic manager 412 may be configured to operate as a switch (e.g., network switch, packet switch), as a hub, or as a router. The behavior of traffic manager 412 may be user configurable (e.g., via a user interface generated for the user on a local electronic display or on a connected terminal). According to an exemplary embodiment, traffic manager 412 is configured to operate with interfaces 402, 404, 406 to create a different collision domain per switch port (e.g., per communication interface). Accordingly, the various BAS devices connected to interfaces 402, 404, 406 will not interfere with each other's transmissions (e.g., on a regular basis). In an exemplary embodiment network communications module 408 is configured to create, maintain and manage multiple virtual local area networks (VLANS) for isolating BAS devices or BAS device groups from the IT systems. Such VLANS may be utilized during deployment of the BAS devices and IT systems, or after such deployment. Further, network communications module 408 may be configured to create, maintain and manage a virtual private network (VPN) for allowing remote access from, for example, a client on the Internet, a wirelessly connected device, etc. According to an exemplary embodiment, traffic manager 412 may be configured to provide switching activity to support network communications according to standards such as 10BASE-T, 100BASE-T, or 1000BASE-T.

According to an exemplary embodiment, connection manager 410 provides the IP address for a newly connected BAS device to BAS configuration module 426. BAS configuration module 426 (e.g., a plug-and-play discovery service) may then be configured to query the newly connected BAS device for parameters (e.g., manufacturer, default protocol, default value reporting frequency, etc.). According to an exemplary embodiment, BAS controller 400 may include a default set of configuration data which may then be updated when specific parameters are received from the BAS devices.

As shown in FIG. 4, one or more databases (e.g., configuration tables 416, project data 418, BAS data 420 (e.g., device data), policy data 422) may be used to store configuration information for BAS controller 400. When an installer is planning the BAS with which BAS controller 400 will be used, the installer can use a local user interface, a remote user interface, or another device to provide project data 418 to BAS controller 400. Project data 418 may relate, for example, a device to a location and the device and the location to a particular HVAC control loop. BAS controller 400 can also be configured to store policy data 422, which may store information such as user names, access rights, storage duration for BAS data (e.g., historical data), value update frequencies, and the like.

BAS configuration module 426 may store configuration data and may also provide information received by querying the BAS devices to a quality of service (e.g., QoS) manager 414 of network communications module 408. Quality of service manager 414 can utilize configuration data 416, project data 418, BAS device data 420, and policy data 422 to update BAS device configuration data and to update quality of service parameters (e.g., stored in quality of service manager 414, stored in configuration data 416, etc.). Quality of service manager 414 can utilize linear optimization, multivariable optimization, matrix-based optimization, one or more weighted functions, or any other method for determining the quality of service parameters of the system. According to an exemplary embodiment, quality of service manager 414 automatically senses the bandwidth (and other parameters) available to BAS controller 400 at uplink interface 406. Using this information, quality of service manager 414 can determine the quality of service parameters for the system. According to an exemplary embodiment, quality of service manager 414 can dynamically adjust the quality of service parameters as conditions at uplink interface 406 change.

According to an exemplary embodiment, connection manager 410 is configured to provide batch updating of connected devices. The batch updating may occur by connection manager 410 providing users with templates, graphical user interfaces, tables, or any other interface for providing configuration controls or fields for entering data. According to an exemplary embodiment, upon discovery of BAS devices, connection manager 410 automatically populates a configuration template for the BAS devices and configures the BAS devices and BAS controller 400 for communications. If a configuration template (e.g., table, grid, other data structure) is partially populated by connection manager 410 upon connecting a BAS device to BAS controller 400, BAS configuration module 426 can be configured to further (e.g., complete) the population of the configuration template based on properties specific to the connected device (e.g., the geolocation of the device, the device type, etc.). Connection manager 410 and BAS configuration module 426 can be configured to work together to maintain an updated set of configuration parameters for the connected BAS devices. The updating provided by connection manager 410 and BAS configuration module 426 may be configured to occur on an automated basis, on an on-demand basis (e.g., user-requested, machine-requested, BAS device-requested, etc.), or on any other basis.

In addition to BAS configuration module 426, BAS module 424 is shown to include a BAS control logic module 430 and BAS device services 432. BAS control logic module 430 may be or include computer code for controlling the BAS devices communicably coupled to BAS controller 400. For example, using data from one or more sensors, BAS control logic module 430 may be configured to adjust a parameter provided to an actuator for heating or cooling a building space. BAS device services 432 may be a set of computer code that, when executed, allows BAS devices to query BAS controller 400 for information (e.g., from BAS data, from another BAS device, etc.).

BAS memory 434 can be one or more memory devices or units of one or more types or configurations for storing BAS data. For example, BAS memory 434 may be solid state random access memory, flash memory, hard drive based memory, optical memory, or any combination thereof. According to an exemplary embodiment, BAS memory 434 includes a relatively small amount of high speed random access memory or cache for temporarily storing the BAS data (e.g., prior to long-term storage, during processing, etc.) in addition to a large amount of memory for longer-term storage (e.g., non-volatile memory, a hard disk, a hard disk array, a RAID array, etc.).

GUI server module 436 of BAS controller 400 may be configured to provide services to one or more connected terminals, computers, or user interfaces. For example, GUI server module 436 may be configured as a web host configured to allow remote access to graphical user interfaces of BAS controller 400. GUI server module 436 may be configured to allow an administrator to populate spreadsheet like tables or other user interface elements (e.g., pop-up windows, dialog boxes, forms, checklists, etc.) for configuring the BAS devices, for adjusting the settings or activities of network communications module 410, or for adjusting the settings or activities of BAS module 424. As updates are received by the system, an update service 428 associated with BAS configuration module 426 can be configured to update configuration data 416 of the system, cause the update of quality of service parameters, update policy data 422, and cause the updates to be pushed to the BAS devices or to other modules of the system that may change their behavior based on updated configuration data (e.g., BAS control logic module 430).

Processing circuit 438 is shown to include a processor 440 and memory 442 for completing the various activities of BAS controller 400 described in the present disclosure. Processor 440 may be a general purpose processor, an application specific integrated circuit (ASIC), a circuit containing one or more processing components, a group of distributed processing components, or other hardware configured for processing. Memory 442 (e.g., memory unit, memory device, storage device, etc.) may be one or more devices for storing data and computer code for completing and/or facilitating the various processes described in the present disclosure when executed by processor 440. Memory 442 may include volatile memory and non-volatile memory. Memory 442 may include database components, object code components, script components, and any other type of information structure for supporting the various activities described in the present disclosure. BAS controller 400 further includes UI module 444 and storage port 446 as described in FIG. 2A.

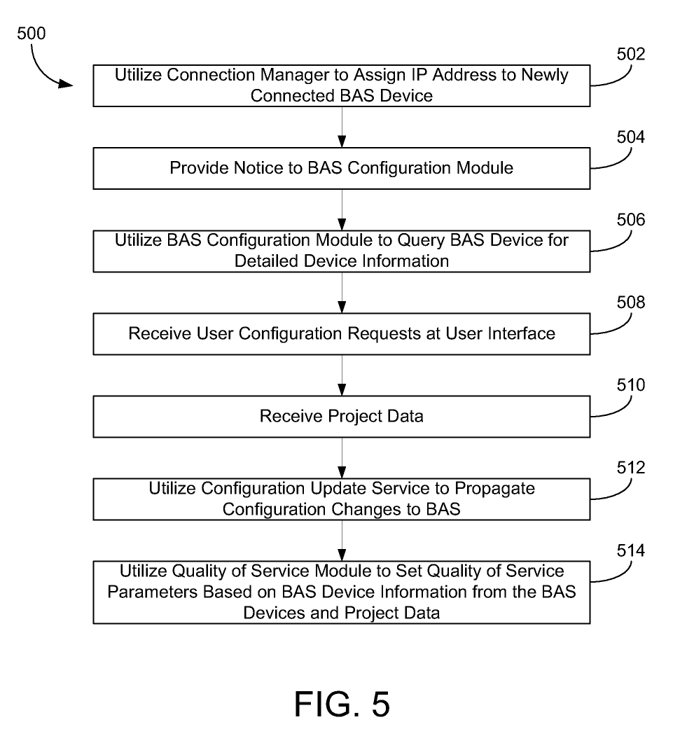

Referring now to FIG. 5, a flow chart of a process 500 for configuring a BAS controller and connected BAS devices is shown, according to an exemplary embodiment. Process 500 includes utilizing the connection manager to assign IP addresses (or other network variables) to a newly connected BAS device (step 502). The connection manager provides notice to a BAS configuration module so that the BAS configuration module begins its activity (step 504). The BAS configuration module queries the newly connected BAS device for detailed device information (step 506). When detailed device information is received from the newly connected BAS device, the information is provided to one or more data stores. User configuration requests are received at the user interface (step 508) and project data (e.g., tabulated project planning data) is received from one or more data sources or interfaces (step 510). A configuration update service is used to propagate configuration changes to BAS devices and to other stores of configuration data (step 512). Process 500 further includes utilizing a quality of service module to set (e.g., calculate, update, analyze, etc.) quality of service parameters based on the BAS configuration data, the detailed device information received from the BAS devices, project data stored in the system, uplink characteristics, and any other information (step 514).

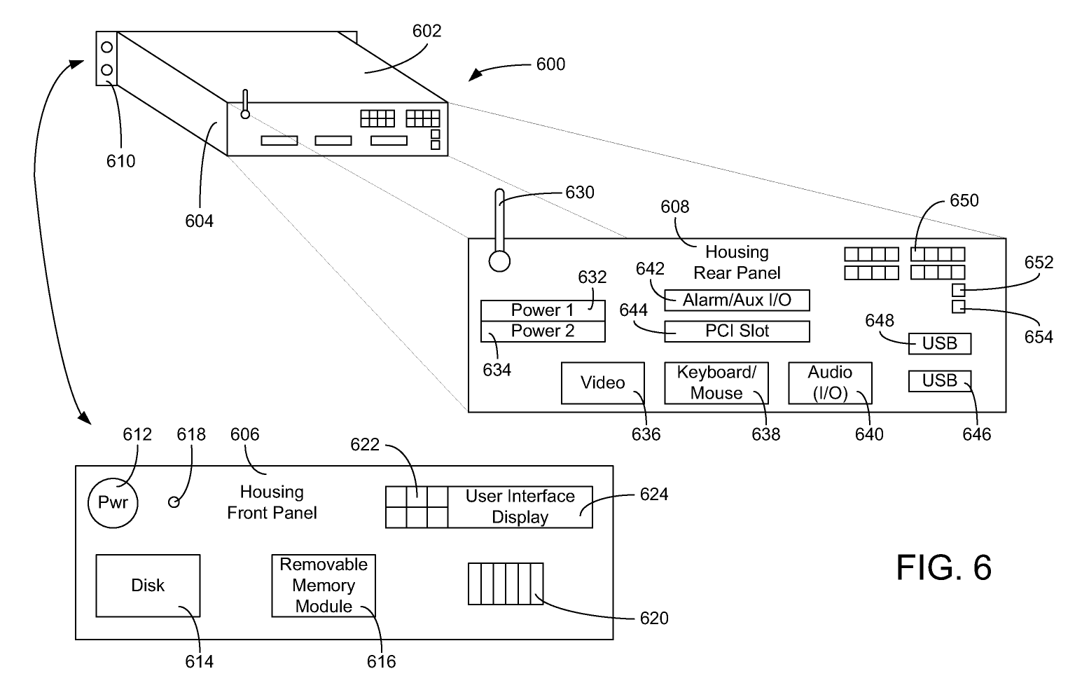

Referring now to FIG. 6, a BAS controller 600, and particularly BAS controller 600's housing, is shown in greater detail, according to an exemplary embodiment. As shown in FIG. 6, the housing is generally shaped as a rectangular box but may be shaped differently according to other exemplary embodiments. In the embodiment shown in FIG. 6, housing side panels 604 cover each side, a housing top panel 602 covers the top of BAS controller 600, a housing rear panel 608 covers the rear of the BAS controller and contains a number of functional elements, and a housing front panel 606 covers the front of the device and contains additional functional elements. In some exemplary embodiments BAS controller 600 may be rack-mounted (e.g., using rack-mount brackets 610). In yet other exemplary embodiments BAS controller 600 does not include rack-mount brackets. Some embodiments of BAS controller 600 may be configured for vertical installation in a device array or rack while other embodiments of BAS controller 600 (e.g., the embodiment shown in FIG. 6) are configured for horizontal installation in a device array or rack. Further, while the embodiment illustrated in FIG. 6 includes panels covering each of the six sides of BAS controller 600, it should be noted that in some exemplary embodiments the panels may be removed or not present; in these cases the BAS module and the network communications module may still be considered to be housed within the housing of BAS controller 600 when within the boundaries of the shape formed by structures (e.g., rails, frame elements, etc.) of BAS controller 600.

Front panel 606 of BAS controller 600 is shown to include a power button (“Pwr”) 612, a slot for adding or removing a hard disk drive 614, a removable memory module 616, one or more indicator lights 618 (e.g., LEDs), one or more external storage interfaces 620 (e.g., USB, iSCSI, firewire), UI elements 622 (e.g., buttons), and a UI display 624 (e.g., an LCD display, an OLED display, etc.). UI elements 622 and UI display 624 may be used to receive configuration data (e.g., quality of service data, policy data, BAS device data, configuration data, etc.).

Rear panel 608 of BAS controller 600 is shown to include an RF antenna 630, multiple power indicators 632, 634, ports for receiving power cables, a video output port 636, a keyboard/mouse port 638, an audio input/output (I/O) port 640, an alarm/auxiliary I/O port 642, a PCI slot 644, and USB ports 646, 648. Rear panel 608 is further shown to include communication ports 650 (e.g., Ethernet ports for connecting the BAS devices and other BAS controllers), and one or more uplink ports 652, 654. RF antenna 630 can be used by a wireless transceiver in BAS controller 600 to connect wireless BAS devices or other wireless devices to BAS controller 600. The same DHCP services, configuration services, and quality of service management services can be provided to BAS devices connected to BAS controller 600 wirelessly.

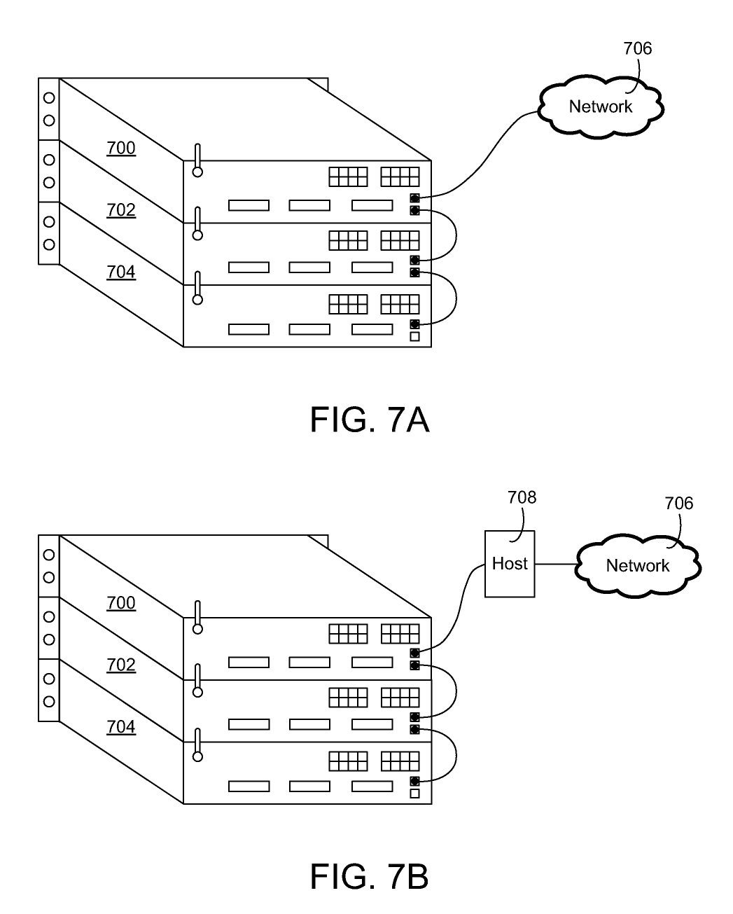

Referring now to FIGS. 7A and 7B, BAS controllers 700, 702, 704 may be configured for linking (e.g., daisy-chaining) to each other so that BAS network 706 can be expanded (scaled-up to manage a larger number of BAS devices or building floors). In such a configuration, the quality of service manager of one of the BAS controllers (e.g., controller 700) is configured to serve as a master while the quality of service managers of the other BAS controllers (e.g., controllers 702, 704) may serve as slave devices. This master-slave decision may occur by only one master “token” being available to a plurality of connected devices. Accordingly, the master quality of service manager can be configured to help distribute the limited resources of the network to the various BAS controllers and the connected BAS devices. In FIG. 7B, a host 708 may exist between BAS controllers 700, 702, 704 and network 706 to manage the array of BAS controllers 700, 702, 704.

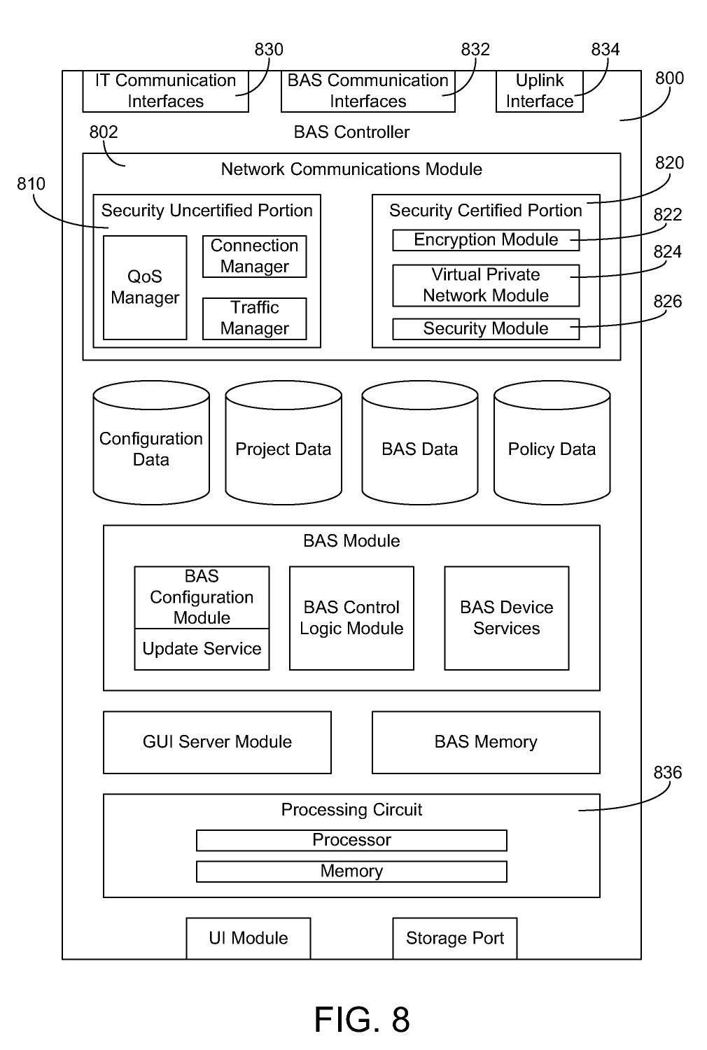

Referring now to FIG. 8, a block diagram of a BAS controller 800 including a network communications module 802 is shown, according to an exemplary embodiment. In the embodiment of FIG. 8, network communications module 802 includes a security certified portion 802 and a security uncertified portion 810. Network communications module 802 includes encryption and virtual private network features such that the network communications handled by module 802 are secure and qualifies for certification under one or more information assurance certifications or standards (e.g., a DoD Information Assurance Certification and Accreditation Process (DIACAP) certification or another standard). Network communications module 802 may include security certified portion 820 configured to adhere to such certifications or standards without further configuration and security uncertified portion 810 not certified without further configuration (e.g., security uncertified portion 810 must be certified after installation and setup of BAS controller 800).

Security certified portion 820 includes an encryption module 822, a virtual private network (VPN) module 824, and a security module 826. Encryption module 822 may include encryption or decryption logic, varying encryption or decryption algorithms, computer code for handling or retaining encryption or decryption keys, or any other computer code for facilitating data encryption activities. According to an exemplary embodiment, communications with BAS controller 800 are encrypted. For example, commands or data for BAS controller 800 are encrypted by a client device or user interface such that the commands must be decrypted before use by BAS controller 800. Similarly, commands or data from BAS controller 800 to other devices are encrypted by BAS controller 800 prior to transmission via interfaces 830, 832, 834.

VPN module 824 is computer code that configures processing circuit 836 of BAS controller 800 to facilitate one or more VPN networks. According to various exemplary embodiments, VPN module 824 may be configured to serve as a VPN server to one or mode client devices that communicate with BAS controller 800. In other exemplary embodiments, VPN module 824 may be configured as a VPN client for a pre-existing VPN (e.g., so that BAS controller 800 can access devices within another network securely, as if it were a part of the other network). VPN module 824 may provide varying levels of security features as may be specified by the certification under which the certified portion of network communications module 802 is certified. For example, some VPNs may use one or more cryptographic tunneling protocols to provide confidential communications, authentication to prevent unauthorized access or identity spoofing, or message integrity checks to check for message alteration.

Security module 826 includes computer code for conducting hacker detection activities and other suspicious activities. Security module 826 may also include computer code for closing ports when not in use, computer code for providing a first or second firewall, or otherwise. Security module 826 may be configured to take one or more corrective actions based on the detection of a hacker or of a suspicious activity. The corrective actions may include closing one or more ports or otherwise restricting communications. The corrective actions may also include blocking one or more users, blocking some IP addresses from communicating with BAS controller 800, re-routing communications managed by network communications module 802, or sending an alert or message to one or more devices regarding the detected hacker or suspicious activities.

Network communications module 802 further includes a security uncertified portion 810 including the quality of service manager, connection manager, and traffic manager as described in FIG. 4. According to various exemplary embodiments, one or more of the quality of service manager, connection manager, or traffic manager may be included in security certified portion 820.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

What is claimed is:

1. A controller for use with a plurality of BAS devices and a plurality of IT devices, the controller comprising:
a housing;
communication interfaces for connecting to the plurality of BAS devices and for connecting to the plurality of IT devices;
a network communication module configured to serve as a network switch for the BAS devices and the IT devices; and
a BAS module configured to manage the BAS devices.

2. The controller of claim 1, wherein the network communications module comprises a security certified portion.

3. The controller of claim 1, wherein the communication interfaces comprise IT communication interfaces and BAS communication interfaces.

4. The controller of claim 1, wherein the network communication module is configured to utilize information from the BAS module to configure the network.

5. The controller of claim 1, wherein the network communications module is configured to set communications priority parameters based on whether a particular port of the communication interfaces is being utilized for communication with a BAS device.

6. The controller of claim 1, wherein the network communications module comprises an IT configuration module configured to provide graphical user interfaces (GUIs) for configuring the IT devices and the BAS devices.

7. The controller of claim 1, wherein the communication interfaces comprise a first high speed Ethernet port and a second high speed Ethernet port and wherein the network communications module logically associates the first high speed Ethernet port with a floor above the controller and logically associates the second high speed Ethernet port with a floor below the controller.

8. The controller of claim 1, wherein the communication interfaces comprise a first high speed Ethernet port and a second high speed Ethernet port and wherein the network communications module logically associates the first high speed Ethernet port with a building zone adjacent the controller and logically associates the second high speed Ethernet port with another building zone adjacent the controller.

9. The controller of claim 1, wherein the network communications module includes at least one IT addressing or naming server.

10. The controller of claim 1, wherein the at least one IT addressing or naming server comprises a dynamic host configuration protocol (DHCP) server configured to allocate IP addresses to the IT devices and the BAS devices connected to the communication interfaces.

11. The controller of claim 1, wherein the at least one IT addressing or naming server comprises at least one of a WINS server and a DNS server.

12. The controller of claim 1, wherein the network communications module is configured to automatically disable the at least one IT addressing or naming server in response to receiving an indication that replacement services for the IT devices have been enabled by another device.

13. The controller of claim 1, wherein the network communications module comprises a network address translation component.

14. The controller of claim 1, further comprising:
an uplink interface for communicating with an enterprise network.

15. The controller of claim 1, wherein the network communications module and the BAS module are configured to share information to configure a network comprising the BAS devices and the plurality of IT devices.

16. The controller of claim 1, wherein the network communications module manages traffic for the plurality of BAS devices and the IT devices.

17. The controller of claim 1, wherein the network communications module is configured to provide a network management user interface.

18. The controller of claim 1, wherein the BAS module is configured to provide a BAS configuration user interface.

19. The controller of claim 1, wherein the BAS module includes circuitry for providing BAS control signals to a first set of BAS devices in response to information received from a second set of BAS devices.

20. A method for operating a building automation system (BAS) controller, comprising:
using a network communications module of the BAS controller to detect the connection of a plurality of BAS devices to communication interfaces of the BAS controller;
using the network communications module to determine whether an uplink device for providing network addressing and naming services is active;
in response to a determination that an uplink device for providing network addressing and naming services is not active, using the network communications module to provide network addressing and naming services to the plurality of BAS devices connected to the communication interfaces of the BAS controller; and
in response to a determination that the uplink device for providing network addressing and naming services is active, using the network communications module to discontinue the provision of network addressing and naming services to the plurality of BAS devices connected to the communication interfaces of the BAS controller.
